(19) United States
(12) Patent Application Publication
(10) Pub. No.: US 2012/0111069 A1
(43) Pub. Date: May 10, 2012

(54) T-shaped handle lock

(76) Inventors: Dale N. Padjen, Pleasant Prairie, WI (US); Timothy J. Padjen, Kenosha, WI (US)

(21) Appl. No.: 12/927,077

(22) Filed: Nov. 8, 2010

(51) Int. Cl. E05B 65/00; E05B 3/00

(52) U.S. Cl. 70/91; 292/336.3

(57) ABSTRACT

An improved T-handle lock assembly for locking a movable member to a stationary member. The lock assembly includes a T-handle lock having a threaded shaft extending therefrom. The threaded shaft is provided with a carriage mounted thereon, the carriage provided with a pair of spaced apart rollers, all mounted on the moveable member. The stationary member is provided with a plate having a carriage receiving opening formed therein. The rear surface of the plate has a pair of opposed ramp surfaces formed thereon which accepts the rollers of the carriage to ride thereon between an open ramped down position to a closed ramped up position. The rear surface of the plate also includes stop means to form a stop position when the carriage has been rotated from the open ramped down position to the locked ramped up position.

### I. FIELD OF THE INVENTION

The present invention relates to an improved mechanical latch assembly for security movable member to a stationary member. The invention has particular application to an improved T-shaped handle lock assembly for locking a vending machine door to the vending machine box while minimizing the work force necessary to turn the handle and engage the lock.

### II. BACKGROUND OF THE INVENTION

The present invention has particular application to vending machines, and to an improved T-shaped handle lock for locking a vending machine door to the vending machine box. It is well known that typically, a T-shaped handle lock assembly is employed to lock the vending machine door to the box. Typically, the T-shaped handle includes a lock that is carried in the T-handle, and when the operator unlocks the lock, the t-handle which is fully spring loaded, is urged outwardly from the door, allowing the operator to then unlatch the T-handle from the securement means. Typically, the T-handle includes a threaded shaft which extends inwardly, and the vending machine box includes a bracket which employs a nut, into which the threaded stud is inserted and screw-threaded therein in order to engage and lock the door to the box. However, it is well known that in order to lock this type of an assembly together, it requires that the operator rotate the handle numerous times in order to allow the threaded shaft of the T-handle to engage in the nut positioned in the vending machine box. This can require numerous turns of the T-handle in order to lock or unlock the latch assembly. The problem that has been realized over the years is that this type of movement required by the operator causes medical difficulties in that the operator's hand and wrist are rotated numerous times each time the lock must be engaged or disengaged. The problem is exacerbated for field operators which must latch and unlatch multiple vending machines during the course of the day in order to fill the machines with the product being vended, and to empty the money from the internal money receptors.

The prior art shows various forms of T-handle locks which have been developed over the years. For example, U.S. Pat. No. 4,899,561 shows a form of a pop out handle lock assembly which represents a typical handle lock assembly used for vending machines. Similarly, U.S. Pat. No. 5,921,119 represents another form of a pop out T-handle lock of the type referenced hereinabove. The prior art has attempted to develop various modifications to the T-handle lock with a view towards simplifying and minimizing the requirement of rotating the handle in order to latch or unlatch the lock. For example, U.S. Pat. No. 5,467,619 represents an attempt to use a latch type of stud which is engaged by a spring-loaded receptor in the internal portions of the vending machine. Another variation is shown in U.S. Pat. No. 5,272,894 which again is an attempt to provide a latch assembly which minimizes the requirement of rotating the handle in order to latch or unlatch the same from the securement means located internally in the vending machine.

The attempts of the prior art to minimize the problem have not been commercially successful. Various difficulties have been determined to exist with respect to the latch assemblies created to date.

The goal of simplifying the latching and unlatching is to develop a T-handle lock assembly which virtually eliminates the requirement to rotate the T-handle more than one complete rotation in order to lock the device, and to affect a similar operation in order to unlatch. Hence, the operator need not engage in numerous turns of the T-handle in order to lock or un-lock the latching assembly.

A further requirement is that the T-handle latch assembly must be developed and designed so that it will retrofit the existing vending machines without the necessity and requirement that the construction of the vending machines be radically altered in order to accommodate the improved T-handle latching assembly.

Another attempt at eliminating the necessity to screw and unscrew a T-handle lock mechanism in a vending machine is shown in U.S. Pat. No. 5,160,180. The device proposed in this patent employs a lock stud provided with a series of male threads formed thereon, and a stud receiving mechanism provided with a series of three cam sleeves. The device is designed with ball bearings which will engage the threads of the stud as the stud is moved into the locking mechanism, and by movement of the one cane sleeve into the mechanism, the ball bearings enter the relief area to disengage from the threads and allow the stud to be withdrawn, thereby opening the lock. The problem with this mechanism is that it requires a number of costly parts which require substantial effort to manufacture. Further, when mechanical problems are encountered in the field, repairs, if possible, are difficult. Therefore, the device has not met any degree of the commercial success.

Another variation of a vending machine lock mechanism is shown in patent publication 2006/0213239. The device described therein employs a rotationally movable bayonet which is operated by a motor. The bayonet is inserted into a receiving fixture mounted in the vending machine cabinet. Upon activation, the bayonet is inserted into a receiving fixture mounted in the vending machine cabinet. Upon activation, the bayonet engages in the receiving fixture and then axially retracts to pull the door into the closed position. Once again, this mechanism is expensive to manufacture and further, requires some degree of reconstruction in order to reconstruct the vending door to accommodate the mechanism which operates the rotational and axial movement of the bayonet.

### III. OBJECTS OF THE PRESENT INVENTION

The object of the present invention is to provide an improved mechanical latch assembly for securing a moveable member to a stationary member of the type which includes a T-shaped handle having a lock incorporated therein including a threaded stud extending rearwardly from the handle through a stud bracket mounted on the moveable member, and stud securement means mounted on the stationary member. The improvement comprises providing a carriage secured on the thread of the stud, the carriage provided with a pair of rollers rotationally mounted on the carriage in spaced apart relation. The securement means mounted within the vending machine box consists of a plate mounted on the stationary member, the plate having a carriage acceptor opening positioned therein. The plate has a front surface and rear surface, with the rear surface having a pair of opposed ramps formed thereon for accepting the rollers of the carriage to ride on the ramps between the ramp down open position and a ramped up closed position. Stop means are provided and associated with the ramps in order to stop the movement of the rollers at the ramp up closed position. The latch assembly operates by moving a movable member or the door of the vending machine, toward the stationary member, or the vending machine box, until the carriage on the stud passes through the plate carriage acceptor opening formed in the plate mounted inside of the vending machine box. The T-handle is rotated approximately 120°-135° to cause the carriage rollers to ride on the opposed ramps formed on the rear surface of the plate from the ramp down open position to the ramped up closed position. When the rollers reach the closed position, the stop means causes the rollers to stop after which the T-handle may be engaged and lock in position.

A further object of the present invention is to provide an improved mechanical latch assembly of the type described, wherein the carriage has a geometric configuration, and the carriage acceptor opening in the plate mounted in the vending machine box has a corresponding geometric configuration which complements the carriage configuration thereby to admit the carriage to pass through the carriage acceptor opening incident to closing and opening the movable member relative to the stationary member.

A further object of the present invention is to provide a mechanical latch assembly of the type described wherein the carriage includes chamfered edges forming the carriage, and the carriage acceptor opening similarly includes chamfered edges along all of the edges bordering the opening thereby to facilitate the insertion of the carriage into and through the carriage acceptor opening.

In conjunction with the foregoing objects, a further object of the present invention is to provide a mechanical T-handle latch assembly of the type described wherein the carriage is mounted on the threaded stud and secured in place by opposed nuts threadedly engaged on the opposed sides of the carriage and wherein each of the opposed nuts may be laterally adjusted to adjust the positioning of the carriage on the stud.

In conjunction with the foregoing objects, a further object of the present invention is to provide an improved mechanical T-handle latch assembly wherein the carriage includes three rounded corners and a fourth square corner, and the carriage acceptor opening is similarly provided with three rounded corners and a fourth square corner forming the opening such that the carriage will only pass into and through the carriage acceptor opening in one orientation.

In conjunction with the foregoing objects, still a further object of the present invention is to provide an improved T-handle latch assembly of the type described, wherein the rear surface of the plate includes a pair of opposed roller pockets which form the stop position of the rollers relative to the ramps, such that the rollers, once turned to the ramped up lock position will fall into the pockets, and achieve the locked position.

In conjunction with the foregoing object, a further object of the present invention is to provide an improved mechanical T-handle latch assembly of the type described, wherein the rear surface will further include a stop pin which is positioned adjacent at least one of the roller pockets, thereby to ensure that the rollers cannot override the roller pockets, in coming to the stopped locked position.

### IV. SUMMARY OF THE INVENTION

In summary, an improved mechanical latch assembly for securing a movable member such as a vending machine door to a stationary member such as a vending machine box, which is of the type including a T-handle having a lock incorporated therein and including a threaded stud extending rearwardly from the handle through a stud bracket mounted on the movable member. Stud securment means is mounted within the stationary member or the vending machine box in a manner known in the art. The improvement consists of providing a carriage which is secured on the thread of the stud. The carriage is provided with a pair of rollers rotationally mounted on the carriage in spaced apart relation. The securement means within the vending machine box comprises a plate mounted therein, the plate having a carriage acceptor opening positioned therein. The carriage acceptor opening is configured to correspond with the carriage configuration such that the carriage may be moved through the carriage acceptor opening incident to the locking an unlocking process. The plate mounted within the vending machine box includes a front surface and a rear surface, with the rear surface having opposed ramps formed thereon for accepting the rollers to ride thereon between a ramp down open position and a ramped up closed position. The rear surface is further provided with a pair of roller pockets positioned at the top of each of the ramps, such that the respective pockets will accept the rollers to fall therein when the locking position is reached. Hence, the roller pockets form the stop means when the vending machine door is in its locked and closed position relative to the vending machine box. As a further improvement, the rear surface of the plate includes a stop pin which is mounted adjacent to one of the roller pockets, to ensure that the rollers do not override the roller pockets.

A further feature of the present invention is to provide a carriage which may be mounted on the threaded stud by means of a pair of opposed nuts. The nuts are engaged on the threaded stud on opposed sides of the carriage, and are designed to be adjustable so that the positioning of the carriage on the threaded stud may be adjusted as necessary in order to ensure that the when the locking function is completed, the vending machine door will be securely sealed to the vending machine box as is required if the vending machine is vending product which must be delivered cold or hot.

Further features of the invention relate to providing components of the system with mechanical features to facilitate the latching and unlatching procedure. For example, the carriage is provided with chamfered edges surrounding the carriage structure, and the carriage acceptor opening is similarly provided with chamfered edges, thereby to facilitate the movement of the carriage through the carriage acceptor opening. A further refinement is to provide a mechanical design which ensures that the carriage can only pass through the carriage acceptor opening in one orientation in order to ensure that the rollers are always oriented properly relative to the ramps located on the rear surface of the plate. This is accomplished by providing the carriage with three rounded corners, and a fourth square corner, and similarly, the carriage acceptor opening is provided with three rounded corners and a fourth square corner. This mechanical feature ensures that the carriage mounted on the threaded stud of the T-handle can only be inserted into the carriage acceptor opening in one orientation thereby ensuring that the rollers will always be properly positioned relative to the ramps located on the rear surface of the plate.

The mechanical features and design of the subject improved T-handle latch assembly requires that the operator only rotate the T-handle for approximately 130° in order to lock or unlock the assembly. Further, the latch assembly has been designed so that once the lock position is achieved, the vending machine door is absolutely sealed to the vending machine box and maintains an airtight seal.

### V. BRIEF DESCRIPTION OF THE DRAWINGS

The invention will best be understood by reference to the following drawings and the detailed description thereof:

FIG. 1 is a perspective view of the improved T-handle latch assembly including the T-handle having a threaded shaft and the carriage mounted thereon, which is positioned on the movable member, and the plate which is mounted within the vending machine box, having a carriage acceptor opening formed therein, with opposed ramps on the rear surface of the plate for accommodating the carriage riding thereon;

FIG. 2 is a top view, partly in cross section, taken along the line 2-2 of FIG. 1, showing the threaded stud with the carriage mounted thereon positioned adjacent to the plate having the carriage acceptor opening formed therein incident to the latching process;

FIG. 3 is a side elevational view, partly in cross section, taken along the line 3-3 of FIG. 1, showing the threaded stud with the carriage mounted thereon positioned immediately in front of the plate having the carriage acceptor opening formed therein and showing the position of the carriage relative to the plate incident to the locking procedure;

FIG. 3A is a cross sectional view taken along the line 3A-3A of FIG. 3, showing the manner in which the carriage is secured to the threaded stud by means of a nut and a key block provided to positively secure the carriage to the threaded stud;

FIG. 4A is an elevational view showing the carriage inserted through the carriage acceptor opening of the plate, and showing the ramp surfaces on the rear surface of the plate at the commencement of the locking procedure;

FIG. 4B illustrates the commencement of the locking procedure rotating the T-handle and therefore the carriage to initiate the rollers on the carriage riding on the ramp rear surface of the plate;

FIG. 4C is an eleveational view, partly cut away, showing the carriage in its midpoint position during the locking procedure with the carriage riding on the ramp rear surface of the plate;

FIG. 4D shows the completion of the rotation of the carriage relative to the plate with the carriage rollers riding into the carriage roller pockets formed in the rear surface of the plate in its fully locked position;

FIG. 4D′, is a cross sectional view taken along the line of 4D′,-4D′ of FIG. 4D in part cross section showing the roller in position in the roller pocket formed on the rear surface of the plate;

FIG. 5A is a side cross sectional view of the seals of the moveable member and the stationary member in their initial position prior to the completed locked position of the latch assembly;

FIG. 5B is a cross sectional view, partly cut away showing the seal of the movable member relative to the seal of the stationary member at the initiation of locking procedure with the seals coming into contact with one another;

FIG. 5C is a cross sectional view, partly cut away, showing the sealing members of the movable members relative to the sealing member of the stationary member when the carriage has achieved the position as shown in FIG. 4C;

FIG. 5D illustrates the seal member of the movable member relative to the seal member of the stationary member when the carriage has been rotated to its fully locked position as illustrated in FIG. 4D, and showing that the complete sealing of the movable member relative to the stationary member has been accomplished.

### VI. DETAILED DESCRIPTION OF DRAWINGS

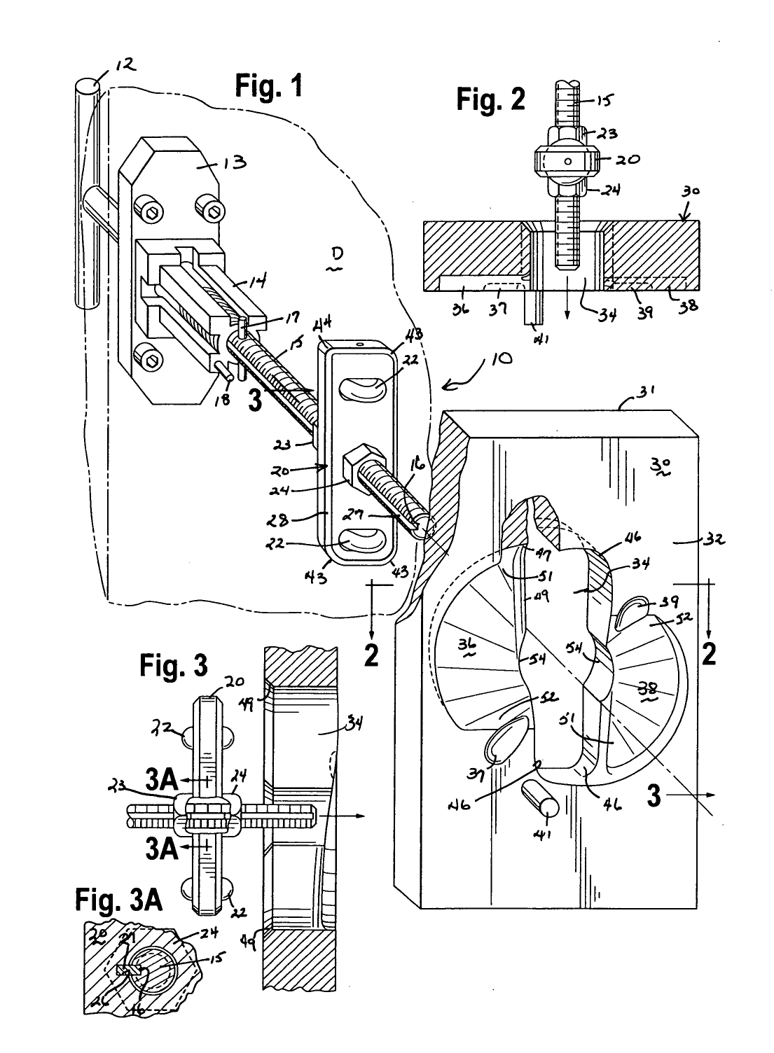

FIG. 1 shows an exploded perspective view of the improved T-handle latch assembly forming the present invention. As shown in FIG. 1, a latch assembly 10 is generally illustrated. The latch assembly 10 is showing to include a T-handle 12 which extends through a bracket 13 and further extends through a guide bracket 14, all as is well known in the art. The T-handle 12 includes a threaded stud 15 which, in most instances, is a continuation of the piece forming the T-handle 12. As shown in FIG. 1, the entire T-handle, bracket, guide bracket and threaded stud are all mounted on the movable member D which, with particular reference the present description, will consist of a door of a vending machine which is designed to be closed and locked to relative to the vending machine box.

As shown in FIG. 1, the threaded stud 15 is provided with a carriage 20 which, in the present illustration assumes a generally rectangular configuration. The carriage 20 includes a pair of opposed rollers 22 which are appropriately mounted such that the rollers 22 are freely rotational. The carriage 20 is held in position on the threaded stud 15 by means of a pair of opposed holding nuts 23 and 24 respectively. It will be observed that the holding nuts 23 and 24 are adjustable along the length of the threaded stud 15 and therefore may adjust the position of the carriage 20 carried on the threaded stud 15.

The carriage 20 is further secured in position on the threaded stud 15 in the manner particularly illustrated in FIG. 3A of the drawings. It will be observed that the threaded stud 15 is provided with a key slot 16 which extends along at least a portion of the length thereof while the carriage is similarly provided with an offset key slot 26. A key block 27 is inserted and fixed within the respective key slot 16 and offset key slot 26 and thereby prevents the carriage 20 from rotational movement relative to the threaded stud 15.

Again with reference to FIG. 1, the latch assembly includes a plate 30 which is appropriately mounted in the stationary member, such as a vending machine box, which is intended to be sealed by the moveable member or door D. The plate 30 includes a front surface 31, and rear surface 32. The plate further includes a substantially centrally positioned carriage acceptor opening 34 which, as illustrated, is designed to receive the carriage 20 therethrough. The rear surface 32 of plate 30 is provided with a pair of opposed ramps 36 and 38 respectively which, as shown, are designed in opposed relations such that they have a ramped down open position, and ramped up closed position. Each of the ramps 36 and 38 respectively includes a roller pocket 37 and 39 respectively, which is formed in the rear surface 32 of the plate 30, and positioned adjacent the ramped up position of each ramp 36 and 38 respectively. The rear surface of the plate 30 is also provided with a stop pin 41 which is mounted on the rear surface 32 of plate 30 and extends rearwardly therefrom for a short distance. The positioning of the stop in 41 will be described more particularly hereinafter.

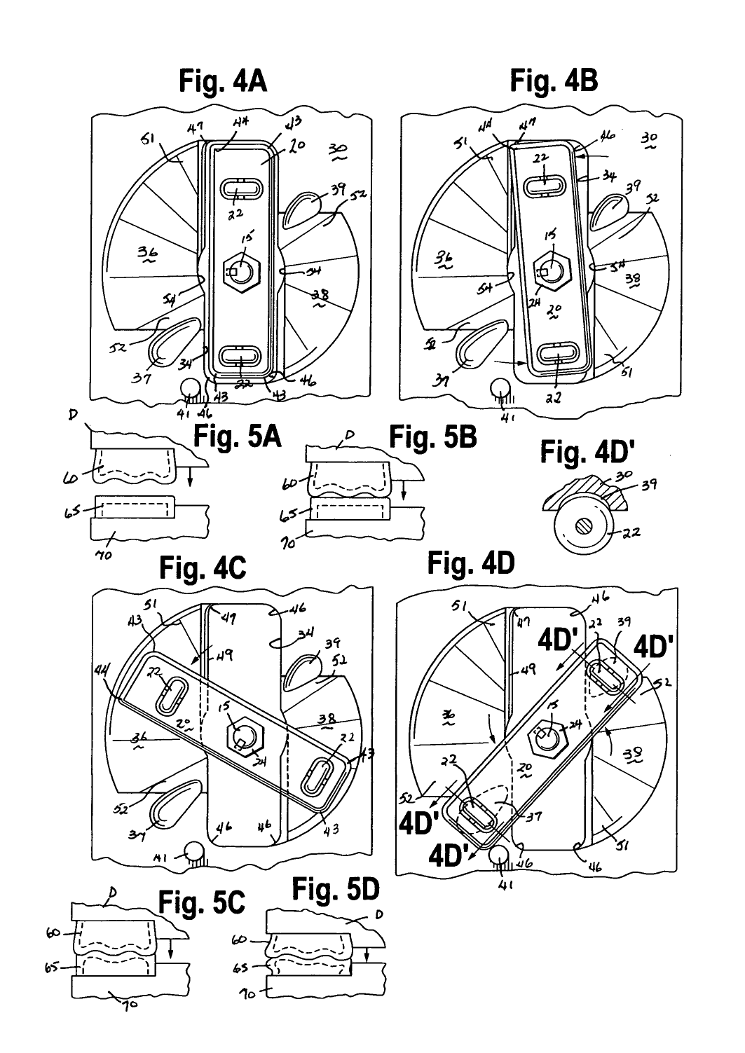

It will further be observed from a view of FIG. 1, and especially FIG. 4A, that the carriage 20, which in the present illustration assumes a generally rectangular configuration with 3 rounded corners 43 and one squared off corner 44. Similarly, the carriage acceptor opening 34 is also provided with 3 rounded corners 46, and a squared corner 47. (See FIG. 4A) It will be observed from FIG. 1, that the carriage 20 is mounted on the threaded stud 15 and positioned such that the three rounded corners 43 and square corner 44 are synchronized to match the 3 rounded corners 46 and square corner 47 positioned in the carriage acceptor opening 34. When the movable member or door D is initiating closing procedure relative to the vending machine box or stationary member, this assures that the carriage 20 will only pass into and through the carriage acceptor opening 34 in one orientation.

The insertion of the carriage 20 into the carriage receptor opening 34 is further facilitated by having the carriage edges provided with chamfers 28 along the entire periphery thereof. Similarly, the carriage acceptor opening 34 is provided with chamfered edges 49 along the peripheral edges thereof as well.

As shown in FIG. 1, the ramps 36 and 38 respectively, are designed to have the low point of each ramp 51 positioned adjacent the point of entry of the carriage 20 the carriage receptor opening 34. The high point 52 of each ramp is positioned at the opposed end of each ramp and, as shown in FIG. 1, includes the roller pockets 37 and 39 positioned the high point 52 of the ramp.

FIGS. 4A-4D illustrate the locking procedure and the path of travel of the carriage 20 relative to the respective ramps 36 and 38. It will be appreciated that once the carriage 20 is inserted through the carriage acceptor opening 34, and the T-handle 12 commences rotation, the carriage rollers 22 will ride on the respective ramps 36 and 38 and start at the low point 51 of the ramp, and travel throughout the ramp to the high point 52 which will thereby draw the movable member D toward to the stationary member (not shown) incident to the closing and locking procedure. When the carriage 20 has reached the locking position, the rollers 22 will drop into the roller pockets 37 and 39 respectively, completing the locking procedure. The latch assembly 10 is designed such that the T-handle 12 be rotated throughout and arc of approximately 120°-135° in order to complete the locking procedure. This eliminates the need for screw-threading and turning the T-handle in order to engage the threaded stud 15 into a lock nut positioned inside of the stationary member in order to achieve the locking of the vending machine door to the box. Hence, it would be appreciated that the locking procedure is greatly simplified since the handle 12 need only be turned an approximate arc of 130°. It will also be appreciated that the opening procedure is simply the reverse of the closing procedure and thereby simplifies the procedure for opening the vending machine.

FIG. 1 illustrates still a further feature of latch assembly 10 of the present invention which facilitates the closing procedure. It will be observed that the carriage acceptor opening 34 is further provided with a pair of opposed arced cut outs 54 approximately centrally positioned therein. It will be appreciated that the modern day vending machines are generally formed from significantly larger boxes and doors and hence, when the vending machine door is closed relative to the box, the door closes throughout an arc. In order to ensure that the carriage 20 will pass through the carriage acceptor opening 34, sufficient tolerances and leeway's must be provided to ensure that none of the structures of the latch assembly mounted on the moveable member D would bind against any portion of the plate 30. The two arced cutouts 54 therefore accommodate the arced pathway of the two holding nuts 23 and 24 which hold the carriage 20 on the threaded stud 15 as the carriage approaches the carriage acceptor opening 34 in order to allow and pass therethrough. Hence, the closing procedure is facilitated by having the peripheral edges of the carriage include chamfered edges 28, as well as the carriage acceptor opening 34 having chamfered edges 49, and having the two arced cutouts 54 to prevent any binding of the holding nuts 23 and 24 and the same align and pass into and through the carriage acceptor opening 34.

FIGS. 4A-4D illustrate the inception and progression of the locking procedure showing the manner in which the carriage 20 is inserted through the carriage acceptor opening 34, and the path of the travel of the rollers 22 as the same travel along the ramps 36 and 38 respectively to the locking position formed by the roller pockets 37 and 39 accepting the rollers 22 dropping therein in order to complete the locking procedure. Further, FIGS. 5A-5D illustrate the manner in which the moveable member D seals against the stationary member or box of the vending machine in terms of the positioning of the seals each of the two respective members, moveable member versus the stationary member. In this connection, it should be noted that most vending machines are designed to vend products that must be kept at cold temperatures, and therefore vending machines are provided with seals surrounding the door as well as the box such that the seals must be fully engaged when the lock position is achieved. FIGS. 5A-5D illustrate the positioning of the seals or gaskets from the inception of the closing procedure to the positioning of the gaskets when the locked position is achieved.

With reference to FIGS. 4A-4D of the drawings, 4A illustrates the position of the respective elements when the carriage is first aligned and commences its travel into and through the carriage acceptor opening 34. It will be observed that the square corner 44 of the carriage 20 is aligned with the square corner of 47 of the carriage acceptor opening 34. It will also be observed that the stop pin 41 is positioned on the rear surface 32 of the plate 30 in a position vertically spaced from the spare corner 47 formed in the carriage acceptor opening 34. This positioning is provided so that once the locked position of the carriage 20 relative to the plate 30 is achieved, the carriage 20 cannot override the roller pocket 39 because the square corner will strike the strike pin 41 in the event in any such rollover. This ensures that the stopped or locked position is achieved and cannot be thwarted by overriding the carriage relative to the ramps.

FIG. 4B shows the commencement of the locking procedure by turning the T-handle 12 thereby turning the carriage 20 relative to the ramps 36 and 38 respectively. FIG. 4C shows the respective rollers 22 entering on to the low point 51 of each of the ramps 36 and 38 respectively. It would be appreciated that as rotation of the T-handle 12 continues, the rollers 22 will continue up each of the respective ramps 36 and 38 respectively, until they reach the high point 52 of each ramp. In FIG. 4D, the carriage 20 has been fully rotated throughout approximately 130°, and the rollers 22 have reached and have dropped into the respective roller pockets 37 and 39. As shown in FIG. 4D, the squared corner 44 of the carriage 20 will be positively stopped by the stop pin 41, and thereby thwart and prevent any rollover of the carriage 20 relative to the ultimate locked position. As shown in FIG. 4D, as the locked position is achieved, the rollers 22 will drop into the roller pockets 37 and 39 respectively, as further illustrated in FIG. 4D prime. When this position is achieved, the lock mechanism located in the T-handle 12 (not shown) may be engaged and thereby lock the vending machine door or movable member D relative to vending machine box. Once again, the locking procedure merely requires that the T-handle 12 be moved approximately throughout an arc of 130° while still achieving a positive lock of the vending machine door relative to the vending machine box.

Again with a view of FIG. 1 of the drawings a further positive feature of ensuring that the arc of travel of the carriage 20 relative to the plate 30 is achieved throughout an arc of 130°, is accomplished by providing the threaded stud 15 with a strike pin 17 while the guide bracket 14 is provided with a stop pin 18. It will be appreciated that the threaded stud 15 which is an extension of the T-handle 12 cannot be rotated beyond its arc of travel because the strike pin 17 will engage and strike up against the stop pin 18, once again thereby ensuring that the arc of travel or rotational movement of the threaded stud 15 is controlled by the positioning of the stop pin 18 relative to the strike pin 17.

FIGS. 5A-5D illustrate the manner in which the vending machine seals will commence engaging and sealing the vending machine with an airtight seal. The moveable member D includes a gasket 60 while the stationary member 70 includes a sealing gasket 65. FIG. 5A illustrates the positioning of the moveable member D relative to the stationary member 70 at the inception of the closing procedure. It will be observed that the gasket 60 is spaced apart from the sealing gasket 65. In FIG. 5B, it will be observed that the gasket 60 now comes into touching contact with the sealing gasket 65 as the carriage 20 is moved onto the ramp 36 as illustrated in FIG. 4B. FIG. 5C illustrates commencement of the compression of the gasket 60 relative to the sealing gasket 65 when the carriage is approximately halfway up the ramps 36 and 38 respectively to the plate 30. FIG. 5D illustrates the complete compression of gasket 60 relative to sealing gasket 65 when the locking procedure has been completed as demonstrated in FIG. 4D. In this position, the moveable member D is now completely locked and sealed relative to the stationary member 70. Once this position is achieved, the vending machine now has an airtight seal and the internal temperature within the product vending machine will be completely maintained.

While there has been described what is considered to be the preferred embodiment of the present invention herein, it will be understood that various modifications will be made therein and all such modifications are intended to be covered by the claims appended hereto.

| D | moveable member |
|---|---|
| 1 | |
| 2 | |
| 3 | |
| 4 | |
| 5 | |
| 6 | |
| 7 | |
| 8 | |
| 9 | |
| 10 | latch assembly(general) |
| 11 | |
| 12 | T-handle |
| 13 | bracket |
| 14 | guide bracket |
| 15 | threaded stud |
| 16 | key slot in 15 |
| 17 | strike pin |
| 18 | stop in of 14 |
| 19 | |
| 20 | carriage |
| 21 | |
| 22 | rollers |
| 23 | holding nut |
| 24 | holding nut |
| 25 | |
| 26 | off-set key slot in 20 |
| 27 | key block |
| 28 | chamfered edges |
| 29 | |
| 30 | plate |
| 31 | front surface |
| 32 | rear surface |
| 33 | |
| 34 | carriage acceptor opening |
| 35 | |
| 36 | ramp |
| 37 | roller pocket |
| 38 | ramp |
| 39 | roller pocket |
| 40 | |
| 41 | stop pin |
| 42 | |
| 43 | rounded corner of 20 |
| 44 | square corner of 20 |
| 45 | |
| 46 | rounded corner of 30 |
| 47 | square corner of 30 |
| 48 | |
| 49 | chamfered edges of 34 |
| 50 | |
| 51 | low point of ramp |
| 52 | high point of ramp |
| 53 | |
| 54 | arched cut outs in 34 |
| 55 | chamfered edge of 34 |
| 56 | |
| 57 | |
| 58 | |
| 59 | |
| 60 | gasket |
| 61 | |
| 62 | |
| 63 | |
| 64 | |
| 65 | sealing gasket |
| 66 | |
| 67 | |
| 68 | |
| 69 | |
| 70 | stationary member |
| 71 | |
| 72 | |
| 73 | |
| 74 | |
| 75 | |
| 76 | |
| 77 | |
| 78 | |
| 79 | |
| 80 | |
| 81 | |
| 82 | |
| 83 | |
| 84 | |
| 85 | |
| 86 | |
| 87 | |
| 88 | |
| 89 | |
| 90 | |
| 91 | |
| 92 | |
| 93 | |
| 94 | |
| 95 | |
| 96 | |
| 97 | |
| 98 | |
| 99 | |
| 100 | |
| 101 | |
| 102 | |
| 103 | |
| 104 | |
| 105 | |
| 106 | |
| 107 | |
| 108 | |
| 109 | |
| 110 | |
| 111 | |
| 112 | |
| 113 | |
| 114 | |
| 115 | |
| 116 | |
| 117 | |
| 118 | |
| 119 | |
| 120 | |
| 121 | |
| 122 | |
| 123 | |

1. An improved mechanical latch assembly for securing a moveable member to a stationary member of the type including a T-shaped handle having a lock incorporated therein and including a threaded stud extending rearwardly from the handle through a stud bracket mounted on the moveable member and stud securement means mounted on the stationary member, the improvement comprising;
a carriage secured on the threaded stud,
said carriage provided with a pair of rollers rotationally mounted on said carriage in spaced apart relation,
said securment means comprising a plate mounted on the stationary member, said plate having a carriage acceptor opening positioned therein,
said plate having a front surface and rear surface,
said rear surface having opposed ramps formed thereon for accepting said rollers to ride thereon between a ramped down open position and ramped up closed position,
and stop means associated with said ramps to stop the movement of said rollers at the ramped up closed position,
thereby said latch assembly operates by moving said moveable member towards said stationary member until said carriage on said stud passes through said plate carriage acceptor opening and said T-handle is rotated to cause said carriage rollers to ride on said opposed ramps from the ramped down open position on the rear surface of said plate to the ramped up closed position thereon until said rollers reach the stop means, at which point said moveable member is secured to said stationary member and the lock on said T-handle is engaged to lock the latch assembly.

2. The latch assembly as set forth in claim 1 above, wherein said carriage has an elongate configuration with said rollers being rotationally mounted thereon at opposed ends of said elongated extant, and said carriage acceptor opening in said plate has a geometric configuration which compliments said carriage elongate configuration thereby to permit said carriage to pass through said carriage acceptor opening incident to closing the moveable member against the stationary member.

3. The latch assembly as set forth in claim 2 above, wherein said carriage includes chamfered edges along all of the edges thereof, and said carriage acceptor opening similarly includes chamfered edges along all of the edges bordering said opening thereby to facilitate the insertion of said carriage into and through said carriage acceptor opening.

4. The latch assembly as set forth in claim 1 above, wherein said carriage is secured in place on said stud by a pair of opposed nuts threadedly engaged on opposed side of said carriage.

5. The latch assembly as set forth in claim 4 above, wherein each of the opposed nuts may be laterally adjusted to adjust the positioning of said carriage on said stud.

6. The latch assembly as set forth in claim 4 above, wherein said stud includes a key slot extended along at least a portion of the length thereof, and said carriage includes an offset key slot formed therein, and a key block is provided to seat between said stud key slot and said carriage offset key slot to further secure said carriage on said stud and prevents said stud carriage from rotating relative to said stud.

7. The latch assembly as set forth in claim 1 above, wherein said rear surface of said plate includes a pair of roller pockets formed therein and positioned adjacent the ramped up position of each of said ramps, each of said roller pockets adapted to receive a corresponding roller therein to secure said carriage in the ramped up closed position when the moveable member is closed against the stationary member.

8. The latch assembly as set forth in claim 2 above, wherein said carriage has a substantially rectangular configuration, and said carriage acceptor opening has a complimentary substantially rectangular configuration.

9. The latch assembly as set forth in claim 8 above, wherein said carriage includes three rounded corners and a fourth square corner, and said carriage acceptor opening is similarly provided with three rounded corners and a fourth square corner, whereby said carriage will only pass into and through said carriage opening in one orientation.

10. The latch assembly as set forth in claim 7 above, wherein the rear surface of said plate includes a stop pin mounted thereon and extending rearwardly therefrom, said stop pin being mounted adjacent to one of said roller pockets and positioned to block one corner of said carriage from rotating beyond the ramped up closed position of said carriage relative to said ramps.

11. The latch assembly for securing a moveable member to a stationary member of the type including a T-shaped handle having a lock incorporated therein and including a threaded stud extending rearwardly from the handle through a stud bracket mounted and the moveable member, with stud securement means mounted on the stationary member and improvement comprising, in combination,
a carriage secured on the threaded stud, said carriage having an elongate configuration,
said carriage providing a pair of opposed rollers rotationally mounted on said carriage at opposed ends thereof,
said securment means mounted on said stationary member comprising a plate having a carriage acceptor opening positioned therein,
said plate having a front surface and rear surface,
said rear surface having opposed ramps formed thereon for accepting said rollers to ride thereon between a ramped down open position and a ramped up closed position,
and a pair of opposed roller pockets formed therein, each of said pockets being positioned adjacent a corresponding ramp at the ramped up closed position and adapted to receive a corresponding roller therein to secure said carriage and the ramped up closed position when the moveable member is closed against the stationary member and the T-handle is rotated,
whereby said latch assembly operates to close and lock a movable member against a stationary member by moving said movable member toward said stationary member until said carriage on said stud passes through said plate carriage acceptor opening and said T-handle is rotated to cause said rollers to ride on the opposed ramps on the rear surface of said plate from the ramped down open position to the ramped up closed position on said plate until said rollers ride into the respective roller pockets at which point said lock is operated to lock the movable member against the stationary member.

12. The latch assembly as set forth in claim 11 above, wherein said carriage has a substantially rectangular configuration and said carriage acceptor opening has a complimentary substantially rectangular configuration.

13. The latch assembly as set forth in claim 12 above, wherein all of the side edges of said carriage are chamfered, and all of the edges bordering said carriage acceptor opening are chamfered, thereby to facilitate the insertion of said carriage into and through said carriage acceptor opening.

14. The latch assembly as set forth in claim 11 above, wherein the rear surface of said plate includes a stop pin mounted thereon and extended rearwardly therefrom said stop pin being mounted adjacent one of said roller pockets and positioned to block one corner of said carriage from rotating beyond the ramped up closed position of said carriage relative to said ramps.

15. The latch assembly as set forth in claim 11 above, wherein said carriage on said stud and said carriage is secured in place on said threaded stud by a pair of opposed nuts threadedly engagaed on the stud on opposed sides of said carriage.

16. The latch assembly as set forth in claim 15 above, wherein said opposed nuts are laterally adjustable along the length of said stud in order to adjust the position of said carriage relative to said stud.

17. The latch assembly as set forth in claim 15 above, wherein said stud further includes a key slot extending along at least a portion of the length thereof, and said carriage includes an offset key slot formed therein, and a key block is provided to seat between said stud key slot and said offset key slot to secure said carriage on said stud and prevent said carriage from rotating relative to said stud.

18. The latch assembly as set forth in claim 11 above, wherein said stud bracket on said movable member includes at least one stop pin mounted thereon and said stud includes a strike pin mounted thereon extending outwardly a distance, said strike pin adapted to permit rotation of said stud only until said strike pin strikes against said stop pin.
